(19) United States
(12) Patent Application Publication
(10) Pub. No.: US 2020/0293014 A1
(43) Pub. Date: Sep. 17, 2020

(54) CASTING EQUIPMENT MONITORING SYSTEM AND CASTING EQUIPMENT MONITORING METHOD

(71) Applicant: SINTOKOGIO, LTD., Nagoya-shi, Aichi (JP)

(72) Inventors: Hideki MORIMOTO, Toyokawa-shi (JP); Koji YAMAGUCHI, Toyokawa-shi (JP); Takahiro YAMAMOTO, Toyokawa-shi (JP)

(73) Assignee: SINTOKOGIO, LTD., Nagoya-shi, Aichi (JP)

(21) Appl. No.: 16/619,551

(22) PCT Filed: Jul. 31, 2018
(86) PCT No.: PCT/JP2018/028632

§ 371 Date: Dec. 5, 2019

(30) Foreign Application Priority Data
Aug. 30, 2017 (JP) 2017-165101

(51) Int. Cl. G05B 19/05; B22D 46/00

(52) U.S. Cl. CPC G05B 19/058; G05B 2219/14006; B22D 46/00

(57) ABSTRACT

A casting equipment monitoring system detects that the condition of casting equipment is deteriorating before the casting equipment fails, or detects that the quality of castings produced by the casting equipment is deteriorating before it becomes clear that the castings are defective products. The casting equipment monitoring system includes: an information collecting device that collects, in real time, data measured by equipment within the casting equipment; and a diagnostic device that compares, in real time, the collected data with a control value, and displays a diagnosis result if the diagnostic device determines that the collected data has deviated from the control value.

### TECHNICAL FIELD

The present invention pertains to a casting equipment monitoring system and a casting equipment monitoring method.

### BACKGROUND

Casting equipment can be operated continuously for 24 hours in order to increase production efficiency. On the other hand, given that casting equipment is operated continuously for 24 hours, it is necessary for the casting equipment to operate continuously without failure and for the quality of castings produced by the casting equipment to be maintained. For this reason, a 24-hour monitoring system for casting equipment is desired.

For example, Patent Document 1 discloses a system for remote support in which, when a molding machine in a foundry has trouble, the location of the trouble is identified from video image information taken of the molding machine, voice information obtained by recording a voice regarding the molding machine, and ladder program information from a control device of the molding machine.

### CITATION LIST

### Patent Literature

Patent Document 1: JP 4871412 B

### SUMMARY OF INVENTION

### Technical Problem

However, a monitoring system that detects that the condition of casting equipment is deteriorating before the casting equipment fails, or detects that the quality of castings produced by the casting equipment is deteriorating before it becomes clear that the castings are defective products, has not existed heretofore.

The present invention was made in view of the above, and a purpose of the invention is providing a casting equipment monitoring system and a casting equipment monitoring method for monitoring the condition of continuously operating casting equipment and the quality of castings produced by casting equipment.

### Solution To Problem

In order to solve the problem described above and achieve the purpose, the casting equipment monitoring system in the present invention comprises: an information collecting device that collects, in real time, data measured by equipment within casting equipment; and a diagnostic device that compares, in real time, the collected data with a control value, and displays a diagnosis result if the diagnostic device determines that the collected data has deviated from the control value.

In addition, the casting equipment monitoring system in the present invention comprises: an information collecting device that collects, in real time, data measured by equipment within casting equipment; a diagnostic device that compares, in real time, the collected data with a control value, and transmits a diagnosis result if the diagnostic device determines that the collected data has deviated from the control value; and a diagnosis result reception device that receives and displays the diagnosis result.

In addition, the casting equipment monitoring method in the present invention comprises: collecting, in real time, data measured by equipment within casting equipment; and comparing, in real time, the collected data with a control value, and displaying a diagnosis result upon determining that the collected data has deviated from the control value.

In addition, the casting equipment monitoring method in the present invention comprises: collecting, in real time, data measured by equipment within casting equipment; a diagnostic device comparing, in real time, the collected data with a control value, and transmitting a diagnosis result to a diagnosis result reception device if the diagnostic device determines that the collected data has deviated from the control value; and the diagnosis result reception device receiving and displaying the diagnosis result.

### Advantageous Effects of Invention

According to the present invention, an effect is provided in which it is possible to detect that the condition of casting equipment is deteriorating before the casting equipment fails, or to detect that the quality of castings produced by the casting equipment is deteriorating before it becomes clear that the castings are defective products.

### BRIEF DESCRIPTION OF DRAWINGS

FIG. 1 is a block diagram representing a functional configuration of a casting equipment monitoring system according to a first embodiment.

FIG. 2 is a block diagram representing a functional configuration of a diagnostic device.

FIG. 3 illustrates an overview of the casting equipment monitoring system.

FIG. 4 is a flow chart illustrating a method for monitoring casting equipment using the casting equipment monitoring system according to the first embodiment.

FIG. 5 illustrates an example of measurement data received by a diagnostic device.

FIG. 6 illustrates an example of a report generated by a control portion of a diagnostic device.

FIG. 7 illustrates other examples of reports generated by a control portion of a diagnostic device.

FIG. 8 illustrates other examples of reports generated by a control portion of a diagnostic device.

FIG. 9 illustrates other examples of reports generated by a control portion of a diagnostic device.

FIG. 10 illustrates other examples of reports generated by a control portion of a diagnostic device.

FIG. 11 is a block diagram representing a functional configuration of a casting equipment monitoring system according to a second embodiment.

FIG. 12 is a block diagram representing a functional configuration of a diagnostic device.

FIG. 13 is a block diagram representing a functional configuration of a diagnosis result reception device.

FIG. 14 illustrates a catalog explaining a casting equipment monitoring system.

FIG. 15 is a flow chart illustrating a method for monitoring casting equipment using the casting equipment monitoring system according to the second embodiment.

FIG. 16 is a block diagram representing a functional configuration of a casting equipment monitoring system according to a third embodiment.

FIG. 17 is a block diagram representing a functional configuration of a diagnostic device.

FIG. 18 is a block diagram representing a functional configuration of a diagnosis result reception device.

FIG. 19 illustrates an example of map information displayed on a display portion.

FIG. 20 illustrates another example of map information displayed on a display portion.

FIG. 21 illustrates an overview of a casting equipment monitoring system.

FIG. 22 is a flow chart illustrating a method for monitoring casting equipment using a casting equipment monitoring system according to the third embodiment.

FIG. 23 illustrates an example of a report generated by a control portion of a diagnostic device.

FIG. 24 illustrates an example of a screen displayed on a display portion.

FIG. 25 illustrates another example of a screen displayed on a display portion.

### DESCRIPTION OF EMBODIMENTS

Herebelow, embodiments for carrying out the casting equipment monitoring system and casting equipment monitoring method according to the present invention will be described on the basis of drawings, with reference to the attached drawings.

### First Embodiment

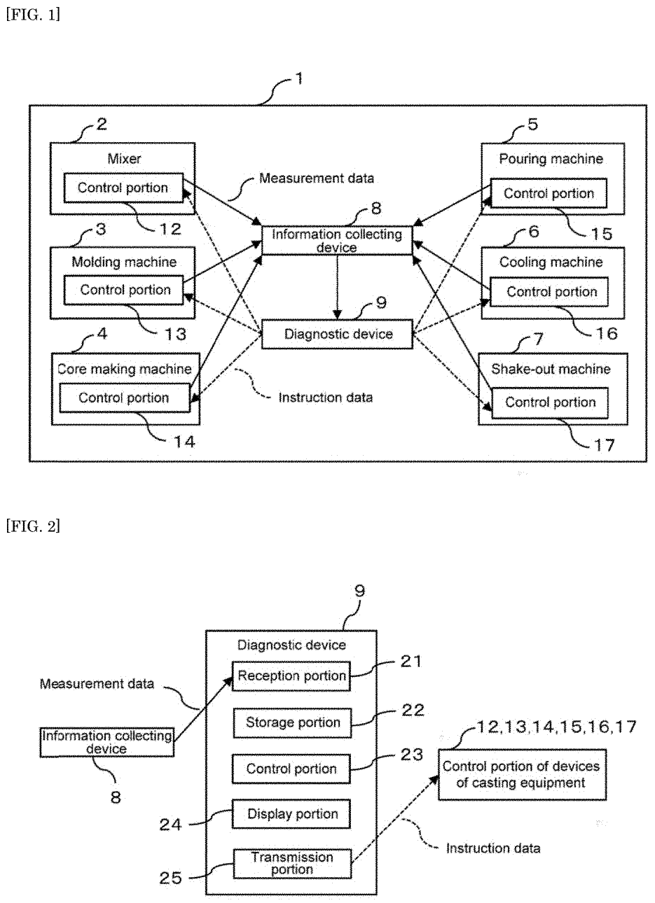

The first embodiment will be explained with reference to the attached drawings. FIG. 1 is a block diagram representing a functional configuration of a casting equipment monitoring system according to the first embodiment. The casting equipment monitoring system 1 comprises: casting equipment comprising a mixer 2, a molding machine 3, a core making machine 4, a pouring machine 5, a cooling machine 6, and a shake-out machine 7; an information collecting device 8; and a diagnostic device 9.

The mixer 2, which is one of the units of casting equipment, adds a binding agent and water to green sand and kneads them to produce kneaded sand. The mixer 2 comprises a control portion 12. The control portion 12 controls the operation of the mixer 2. All measurement data pertaining to a kneading step in the mixer 2 is aggregated into the control portion 12. Examples of measurement data pertaining to the kneading step include: the CB value (compactability value), which is a property of the kneaded sand; the temperature of the green sand and kneaded sand; the moisture content of the green sand and kneaded sand; and the operation sound (noise) of the mixer 2. Such measurement data is treated as items to be inspected in the kneading step. The control portion 12 is a computer or a PLC (programmable logic controller).

The molding machine 3, which is one of the units of casting equipment, molds master molds (cope and drag). The molding machine 3 comprises a control portion 13. The control portion 13 controls the operation of the molding machine 3. All measurement data pertaining to a master mold molding step in the molding machine 3 is aggregated into the control portion 13. Examples of measurement data pertaining to the master mold molding step include: mechanical vibration; actuator oil pressure; blow-in air pressure (pressure in aeration); air pressure in sand tank; kneaded sand temperature; sand amount in sand tank; molten metal temperature; mold strength; compressibility; dimensional displacement; and timing. Such measurement data is treated as items to be inspected in the master mold molding step. The control portion 13 is a computer or a PLC.

The core making machine 4, which is one of the units of casting equipment, molds cores. The core making machine 4 comprises a control portion 14. The control portion 14 controls the operation of the core making machine 4. All measurement data pertaining to a core molding step in the core making machine 4 is aggregated into the control portion 14. Examples of measurement data pertaining to the core molding step include core sand blow-in (blowing) pressure, blow-in time, air pressure in blow tank, air pressure in blow head, and die temperature. Such measurement data is treated as items to be inspected in the core molding step. The control portion 14 is a computer or a PLC.

The pouring machine 5, which is one of the units of casting equipment, pours molten metal into molds in which master molds and cores were subjected to mold assembly. The pouring machine 5 comprises a control portion 15. The control portion 15 controls the operation of the pouring machine 5. All measurement data pertaining to a pouring step in the pouring machine 5 is aggregated into the control portion 15. Examples of measurement data pertaining to the pouring step include pouring flow rate, pouring time, and ladle tilting speed. Such measurement data is treated as items to be inspected in the pouring step. The control portion 15 is a computer or a PLC.

The cooling machine 6, which is one of the units of casting equipment, cools molds into which molten metal was poured. The cooling machine 6 comprises a control portion 16. The control portion 16 controls the operation of the cooling machine 6. All measurement data pertaining to a cooling step in the cooling machine 6 is aggregated into the control portion 16. Examples of measurement data pertaining to the cooling step include cooling initiation time, cooling completion time, ambient temperature, and air temperature. Such measurement data is treated as items to be inspected in the cooling step. The control portion 16 is a computer or a PLC.

The shake-out machine 7, which is one of the units of casting equipment, separates molds into foundry sand and castings that were cast. The shake-out machine 7 comprises a control portion 17. The control portion 17 controls the operation of the shake-out machine 7. All measurement data pertaining to a shake-out step in the shake-out machine 7 is aggregated into the control portion 17. Examples of measurement data pertaining to the shake-out step include: shake-out machine noise; the vibration amount of the vibration motor of the shake-out machine; the temperature of the vibration motor of the shake-out machine; and the moisture value of foundry sand after molds are subjected to shake-out with the shake-out machine. Such measurement data is treated as items to be inspected in the shake-out step. The control portion 17 is a computer or a PLC.

### (Information Collecting Device)

The information collecting device 8 collects, in real time, data measured by the devices of the casting equipment (the mixer 2, the molding machine 3, the core making machine 4, the pouring machine 5, the cooling machine 6, and the shake-out machine 7). Specifically, the information collecting device 8 collects, in real time: measurement data aggregated into the control portion 12 of the mixer 2; measurement data aggregated into the control portion 13 of the molding machine 3; measurement data aggregated into the control portion 14 of the core making machine 4; measurement data aggregated into the control portion 15 of the pouring machine 5; measurement data aggregated into the control portion 16 of the cooling machine 6; and measurement data aggregated into the control portion 17 of the shake-out machine 7. The information collecting device 8 is a data logger.

In the present embodiment, data from the control portions of the devices of the casting equipment is collected in one information collecting device 8, but the same number of information collecting devices 8 as there are devices in the casting equipment may be provided to collect data from the control portions of the devices in separate information collecting devices 8.

### (Diagnostic Device)

The diagnostic device 9 uses the collected measurement data to diagnose the condition of the devices of the casting equipment and the quality of castings produced by the casting equipment. FIG. 2 is a block diagram representing a functional configuration of the diagnostic device 9. The diagnostic device 9 comprises a reception portion 21, a storage portion 22, a control portion 23, a display portion 24, and a transmission portion 25.

The reception portion 21 receives, in real time, measurement data collected by the information collecting device 8. The storage portion 22 stores the received measurement data. Control values corresponding to measurement data in the devices of the casting equipment and countermeasures for when there is deviation from the control values are also pre-stored in the storage portion 22. Furthermore, the storage portion 22 stores reports generated by the control portion 23.

The control portion 23 compares, in real time, collected measurement data with the control values, and upon determining that the collected data has deviated from a control value, causes the display portion 24 to display a diagnosis result (warning) indicating that there is a risk that a fault will occur. Furthermore, the control portion 23 causes the transmission portion 25 to transmit, to the device of the casting equipment that has deviated from the control value, instruction data for changing a setting condition in the device so that the control value is not exceeded. Furthermore, the control portion 23 periodically generates a report based on the collected data.

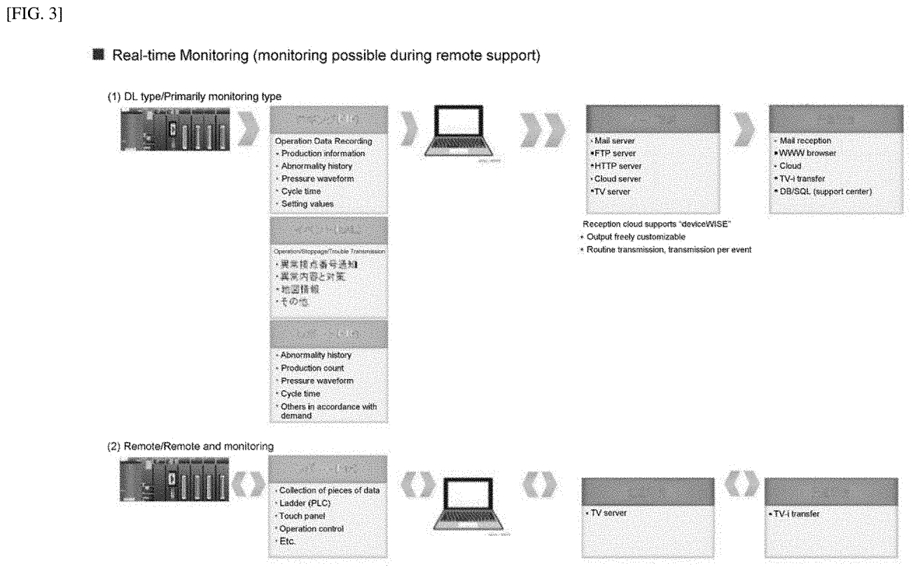

The display portion 24 displays the measurement data received by the reception portion 21, a report generated by the control portion 23, and a diagnosis result (warning). The transmission portion 25 transmits instruction data to the device of the casting equipment that has deviated from the control value. The diagnostic device 9 is a computer. FIG. 3 illustrates an overview of the casting equipment monitoring system 1.

### (Method for Monitoring Casting Equipment)

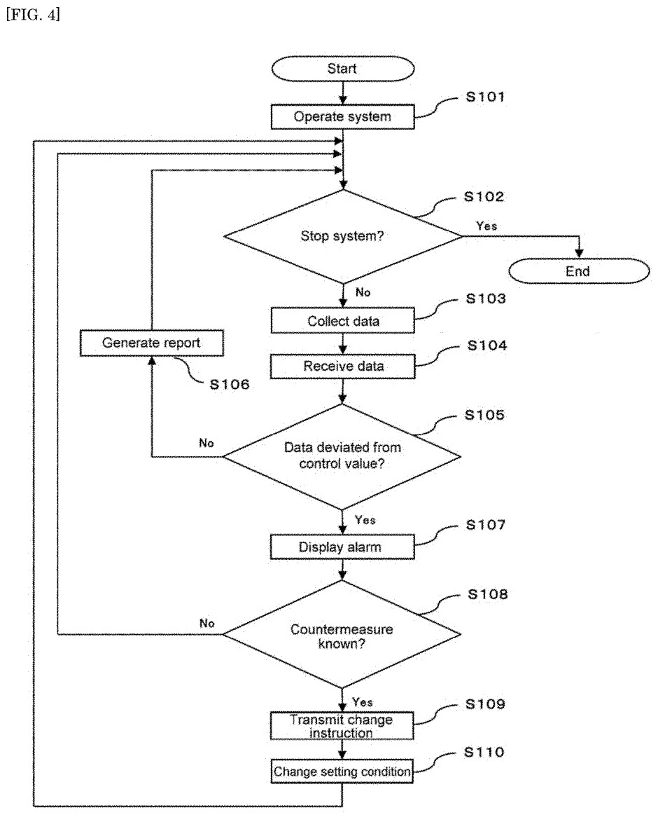

Next, the method for monitoring casting equipment using the casting equipment monitoring system 1 according to the first embodiment will be explained. FIG. 4 is a flow chart illustrating the method for monitoring casting equipment using the casting equipment monitoring system 1 according to the first embodiment.

First, the casting equipment monitoring system 1 (devices of the casting equipment) is operated (step S101). Then, the casting equipment is continuously monitored until the casting equipment monitoring system 1 (devices of the casting equipment) stops (step S102: Yes).

Simultaneously with the operation of the casting equipment monitoring system 1, the information collecting device 8 collects, in real time, data measured by the mixer 2, the molding machine 3, the core making machine 4, the pouring machine 5, the cooling machine 6, and the shake-out machine 7 (step S103).

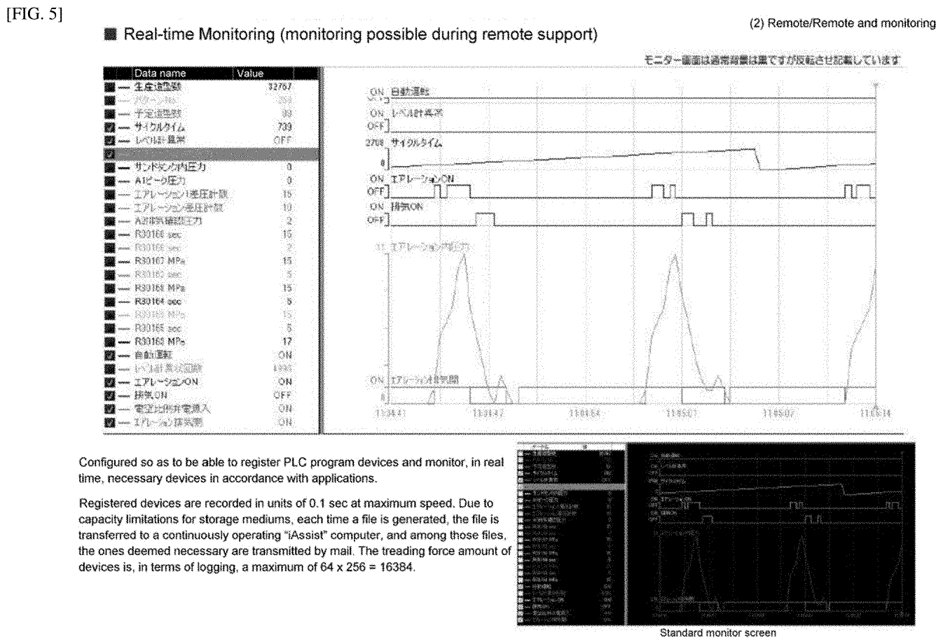

Next, the reception portion 21 of the diagnostic device 9 receives, in real time, the measurement data collected by the information collecting device 8 (step S104). FIG. 5 illustrates an example of measurement data received by the diagnostic device 9. In the present drawing, measurement data collected from the molding machine 3 is illustrated not in the form of raw data, but rather in the form of edited data that is displayed on the display portion 24. Looking at the drawing, it can be seen that pressure in aeration, which is one of the items of measurement data, is displayed.

Next, the control portion 23 of the diagnostic device 9 compares, in real time, the received measurement data with control values pre-stored in the storage portion 22 of the diagnostic device 9 (step S105). If the control portion 23 determines that the measurement data has not deviated from a control value (step S105: No), data collection continues.

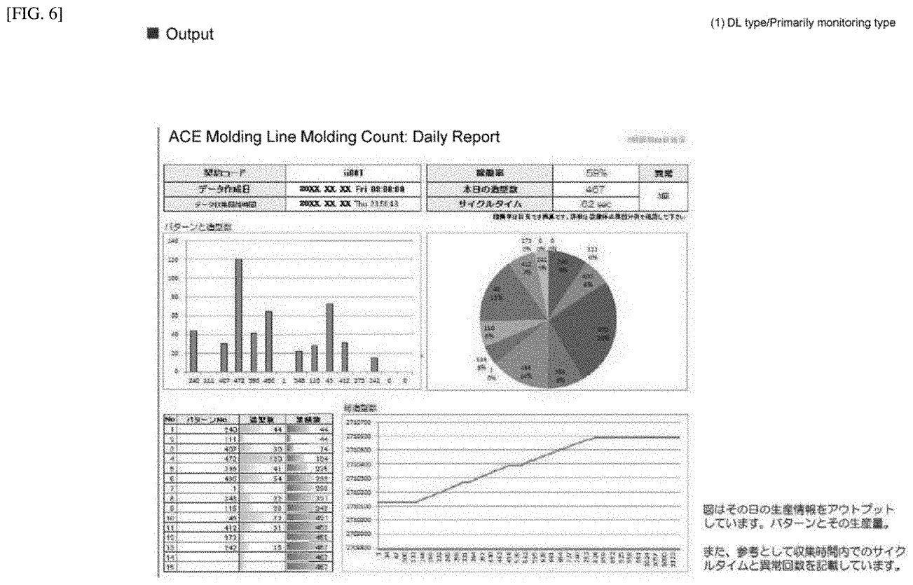

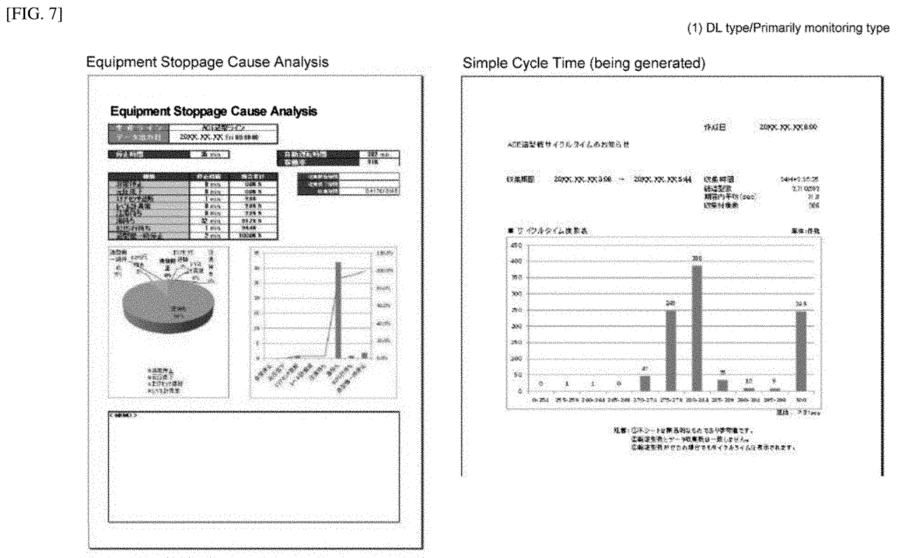

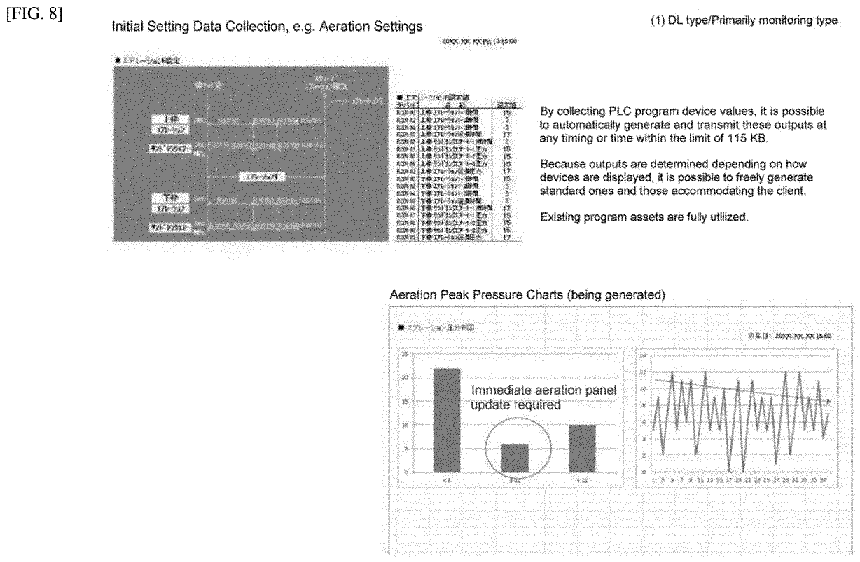

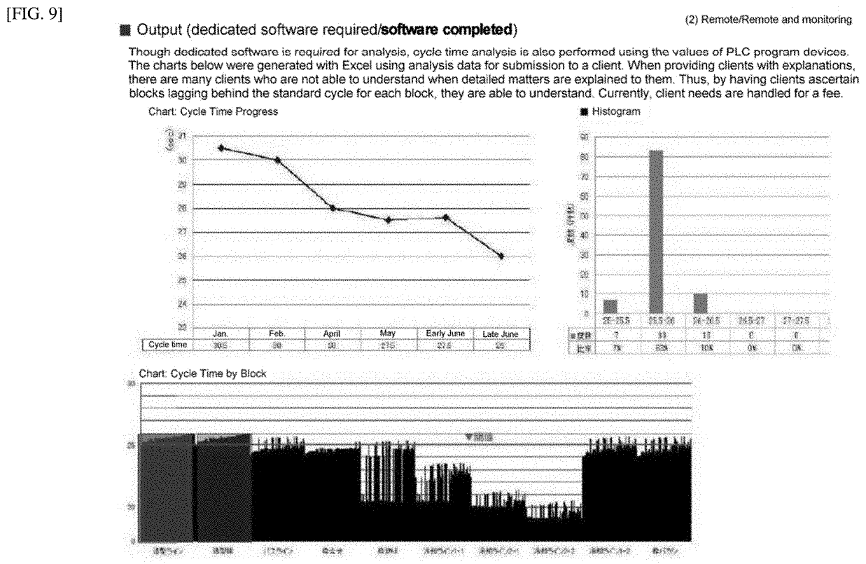

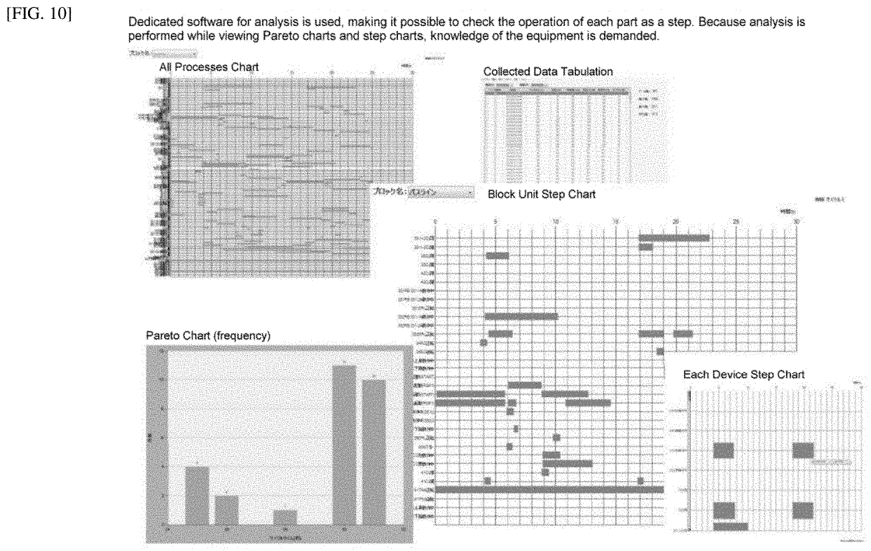

Then, the control portion 23 periodically generates a report based on the collected data (step S106). FIG. 6 illustrates an example of a report generated by the control portion 23 of the diagnostic device 9. In the present drawing, production information such as master mold molding count and cycle time is summarized in an easily understood manner using tables and graphs based on measurement data transmitted from the molding machine 3. The time for collecting information in order to generate a report may be arbitrary. For example, a report may be automatically generated every eight hours and stored in the storage portion 22 of the diagnostic device 9 so that an operator can check the report later on. In addition, FIG. 7-10 illustrate other examples of reports generated by the control portion 23 of the diagnostic device 9.

On the other hand, if the control portion 23 determines that the measurement data has deviated from the control value (step S105: Yes), the display portion 24 of the diagnostic device 9 displays a diagnosis result (warning) indicating that there is a risk that a fault will occur (step S107). For example, in the measurement data collected from the molding machine 3, if the pressure in aeration value has deviated from the lower limit of the control value, a diagnosis result (warning) is displayed indicating that there is a risk that a fault will occur in the molding machine 3.

Furthermore, if the control portion 23 knows a specific method for dealing with the fault (step S108: Yes), the control portion 23 transmits instruction data from the transmission portion 25 of the diagnostic device 9 to the equipment (any of the mixer 2, the molding machine 3, the core making machine 4, the pouring machine 5, the cooling machine 6, and the shake-out machine 7) within the casting equipment in which the measurement data has deviated from the control value, the instruction data instructing the equipment to change a setting condition so that the control value is not exceeded (step S109). For example, in the measurement data collected from the molding machine 3, if the pressure in aeration value has deviated from the lower limit of the control value, instruction data that causes the supply of air to increase by a predetermined value is transmitted to the control portion 13 of the molding machine 3 such that the pressure in aeration increases and returns to the range of the control values. Note that depending on the type of control value, instruction data that stops the equipment is transmitted in some cases.

One of the control portions 12, 13, 14, 15, 16, 17 of the equipment that has received the instruction data from the diagnostic device 9 changes a setting condition in the equipment on the basis of the instruction data (step S110). For example, the control portion 13 of the molding machine 3 increases the supply of air by a predetermined value on the basis of the instruction data. As a result, the pressure in aeration value again comes within range of the control values, and it is possible to obviate the occurrence of a fault due to a decrease in pressure in aeration.

If the control portion 23 does not know a specific method for dealing with the fault (step S108: No), the fault is dealt with by an operator who has checked the diagnosis result (warning) displayed on the display portion 24, and even after a setting condition has been changed, data collection continues (step S103), and the monitoring of the casting equipment by the diagnostic device 9 continues.

As mentioned previously, this series of operations is performed until the casting equipment monitoring system 1 (equipment of the casting equipment) stops (step S102: Yes). Once the casting equipment monitoring system 1 (devices of the casting equipment) stops, the monitoring of the casting equipment ends.

In the present embodiment, a diagnosis result (warning) is displayed on the display portion 24 when there is a risk that a fault will occur, but the diagnostic device may be configured so as to have a speaker and issue a diagnosis result (warning) as audio, and a configuration is also possible in which a diagnosis result (warning) is issued using both screen display and audio.

In this manner, according to the casting equipment monitoring system according to the first embodiment, the information collecting device collects, in real time, data measured by the devices of the casting equipment, and the diagnostic device compares, in real time, the collected measurement data with a control value, and displays a diagnosis result (warning) indicating that there is a risk that a fault will occur if the diagnostic device determines that the collected data has deviated from the control value. This makes it possible to detect that the condition of casting equipment is deteriorating before the casting equipment fails, or to detect that the quality of castings produced by the casting equipment is deteriorating before it becomes clear that the castings are defective products.

In addition, according to the casting equipment monitoring system according to the first embodiment, if the diagnostic device determines that the collected data has deviated from a control value, the diagnostic device transmits, to the equipment that has deviated from the control value, instruction data for changing a setting condition in the equipment. This makes it possible to automatically stabilize the condition of casting equipment and the quality of castings.

### Second Embodiment

Next, a second embodiment of the casting equipment monitoring system according to the present invention will be explained. Note that in the second embodiment explained below, the same reference numerals are used in the drawings to designate features common to those in the first embodiment, and descriptions thereof will be omitted. In the second embodiment, diagnosis results and reports generated by a diagnostic device are transmitted to a diagnosis result reception device at a position remote from the casting equipment monitoring system, and the diagnosis result reception device gives change instructions to the diagnostic device based on diagnosis results.

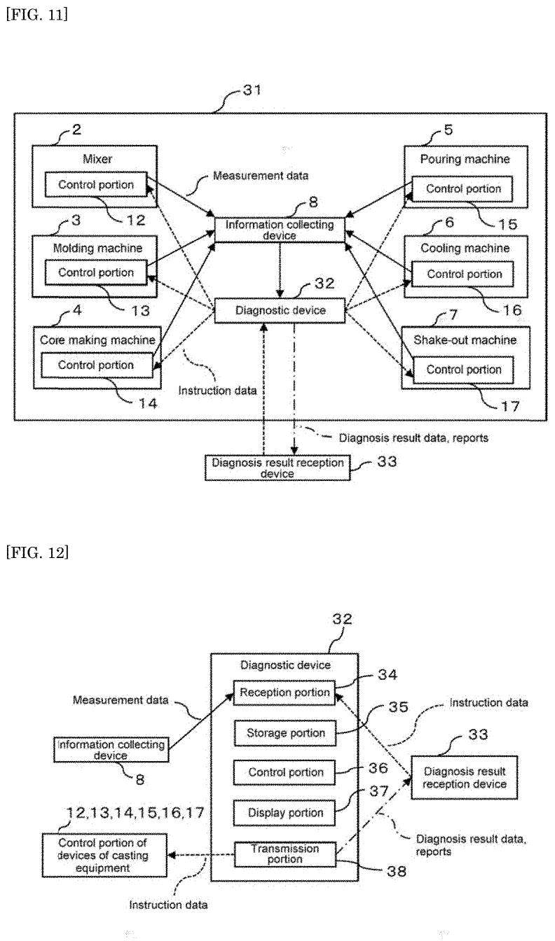

The second embodiment will be explained with reference to the attached drawings. FIG. 11 is a block diagram representing a functional configuration of the casting equipment monitoring system according to the second embodiment. The casting equipment monitoring system 31 comprises: casting equipment comprising a mixer 2, a molding machine 3, a core making machine 4, a pouring machine 5, a cooling machine 6, and a shake-out machine 7; an information collecting device 8; a diagnostic device 32; and a diagnosis result reception device 33.

The mixer 2 adds a binding agent and water to green sand and kneads them to produce kneaded sand. The mixer 2 comprises a control portion 12. The control portion 12 controls the operation of the mixer 2. All measurement data pertaining to a kneading step in the mixer 2 is aggregated into the control portion 12. The control portion 12 is a computer or a PLC.

The molding machine 3 molds master molds (cope and drag). The molding machine 3 comprises a control portion 13. The control portion 13 controls the operation of the molding machine 3. All measurement data pertaining to a master mold molding step in the molding machine 3 is aggregated into the control portion 13. The control portion 13 is a computer or a PLC.

The core making machine 4 molds cores. The core making machine 4 comprises a control portion 14. The control portion 14 controls the operation of the core making machine 4. All measurement data pertaining to a core molding step in the core making machine 4 is aggregated into the control portion 14. The control portion 14 is a computer or a PLC.

The pouring machine 5 pours molten metal into molds in which master molds and cores were subjected to mold assembly. The pouring machine 5 comprises a control portion 15. The control portion 15 controls the operation of the pouring machine 5. All measurement data pertaining to a pouring step in the pouring machine 5 is aggregated into the control portion 15. The control portion 15 is a computer or a PLC.

The cooling machine 6 cools molds into which molten metal was poured. The cooling machine 6 comprises a control portion 16. The control portion 16 controls the operation of the cooling machine 6. All measurement data pertaining to a cooling step in the cooling machine 6 is aggregated into the control portion 16. The control portion 16 is a computer or a PLC.

The shake-out machine 7 separates molds into foundry sand and castings that were cast. The shake-out machine 7 comprises a control portion 17. The control portion 17 controls the operation of the shake-out machine 7. All measurement data pertaining to a shake-out step in the shake-out machine 7 is aggregated into the control portion 17. The control portion 17 is a computer or a PLC.

The information collecting device 8 collects, in real time, data measured by the devices of the casting equipment (the mixer 2, the molding machine 3, the core making machine 4, the pouring machine 5, the cooling machine 6, and the shake-out machine 7). The information collecting device 8 is a data logger.

### (Diagnostic Device)

The diagnostic device 32 uses the collected measurement data to diagnose the condition of the devices of the casting equipment and the quality of castings produced by the casting equipment. FIG. 12 is a block diagram representing a functional configuration of the diagnostic device. The diagnostic device 32 comprises a reception portion 34, a storage portion 35, a control portion 36, a display portion 37, and a transmission portion 38.

The reception portion 34 receives, in real time, measurement data collected by the information collecting device 8, or receives instruction data from the diagnosis result reception device 33. The storage portion 35 stores the received measurement data. Control values corresponding to the measurement data in the devices of the casting equipment are also pre-stored in the storage portion 35. Furthermore, the storage portion 35 stores reports generated by the control portion 36.

The control portion 36 compares, in real time, the collected measurement data with the control values, and if the control portion 36 determines that collected data has deviated from a control value, the control portion 36 generates diagnosis result data and causes the display portion 37 to display the generated diagnosis result data. Then, the control portion 36 causes the transmission portion 38 to transmit the diagnosis result data. When the control portion 36 receives instruction data from the diagnosis result reception device 33, the control portion 36 causes the transmission portion 38 to transmit the instruction data to the device of the casting equipment that has deviated from the control value. Furthermore, the control portion 36 periodically generates a report based on the collected data, and causes the transmission portion 38 to transmit the report.

The display portion 37 displays measurement data received by the reception portion 34, reports generated by the control portion 36, and diagnosis results (warnings) indicating that there is a risk that a fault will occur. Note that in the present embodiment, the display portion 37 may be omitted in the diagnostic device 32. In this case, the control portion 36 causes the transmission portion 38 to transmit the generated diagnosis result data directly.

The transmission portion 38 transmits diagnosis result data or reports to the diagnosis result reception device 33, and transmits instruction data to the device of the casting equipment that has deviated from the control value. The diagnostic device 32 is a computer.

Note that in the present embodiment, emails are used when the diagnostic device 32 transmits diagnosis result data or reports to the diagnosis result reception device 33 and when the diagnostic device 32 receives instruction data from the diagnosis result reception device 33, but other methods may be used.

### (Diagnosis Result Reception Device)

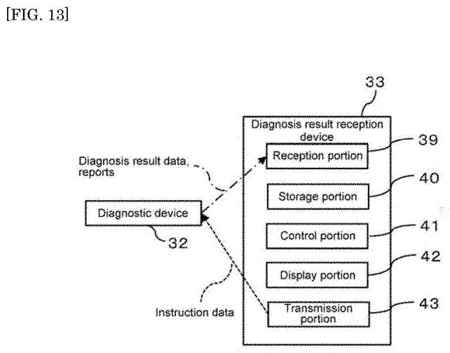

The diagnosis result reception device 33 receives diagnosis result data or reports from the diagnostic device 32. In addition, the diagnosis result reception device 33 gives change instructions to the diagnostic device 32 based on the diagnosis result data. The diagnosis result reception device 33 is at a position remote from the casting equipment, the information collecting device 8, and the diagnostic device 32. FIG. 13 is a block diagram representing a functional configuration of the diagnosis result reception device. The diagnosis result reception device 33 comprises a reception portion 39, a storage portion 40, a control portion 41, a display portion 42, and a transmission portion 43.

The reception portion 39 receives diagnosis result data or reports from the diagnostic device 32. The storage portion 40 stores the received diagnosis result data or reports. Countermeasures for when measurement data from devices of the casting equipment has deviated from control values are also pre-stored in the storage portion 40.

The control portion 41 causes diagnosis results (warnings) indicating that there is a risk that a fault will occur, or reports, to be displayed on the display portion 42 based on diagnosis result data. Furthermore, on the basis of the diagnosis result data, the control portion 41 causes the transmission portion 43 to transmit, to the device of the casting equipment that has deviated from a control value, instruction data for changing a setting condition in the device so that the control value is not exceeded.

The display portion 42 displays diagnosis results (warnings) or reports. The transmission portion 43 transmits instruction data to the diagnostic device 32. The diagnosis result reception device 33 is a computer.

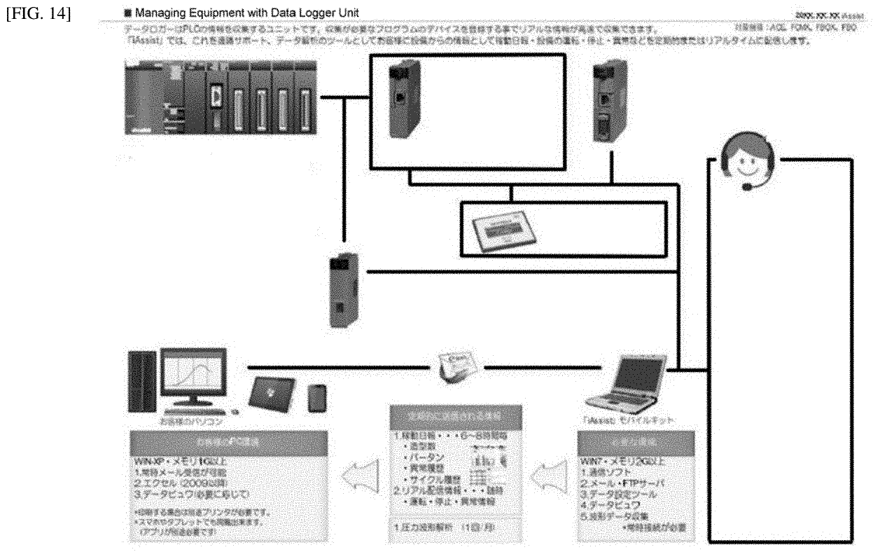

Note that in the present embodiment, emails are used when the diagnosis result reception device 33 receives diagnosis result data or reports from the diagnostic device 32 and when the diagnosis result reception device 33 transmits instruction data to the diagnostic device 32, but other methods may be used. FIG. 14 illustrates a catalog explaining the casting equipment monitoring system 31.

### (Method for Monitoring Casting Equipment)

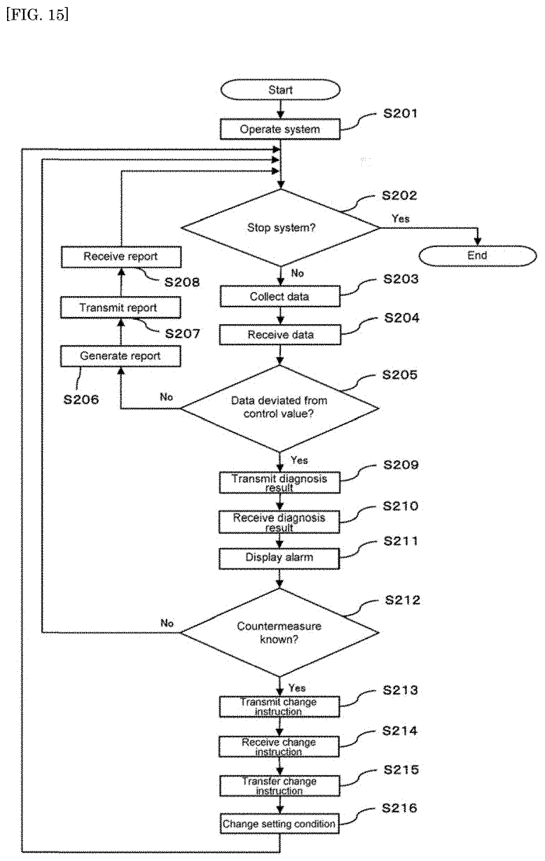

Next, the method for monitoring casting equipment using the casting equipment monitoring system 31 according to the second embodiment will be explained. FIG. 15 is a flow chart illustrating the method for monitoring casting equipment using the casting equipment monitoring system 31 according to the second embodiment.

First, the casting equipment monitoring system 31 (devices of casting equipment) is operated (step S201). Then, the casting equipment is continuously monitored until the casting equipment monitoring system 31 (devices of casting equipment) stops (step S202: Yes).

Simultaneously with the operation of the casting equipment monitoring system 31, the information collecting device 8 collects, in real time, data measured by the mixer 2, the molding machine 3, the core making machine 4, the pouring machine 5, the cooling machine 6, and the shake-out machine 7 (step S203).

Next, the reception portion 34 of the diagnostic device 32 receives, in real time, the measurement data collected by the information collecting device 8 (step S204).

Next, the control portion 36 of the diagnostic device 32 compares, in real time, the received measurement data with control values pre-stored in the storage portion 35 of the diagnostic device 32 (step S205). If the control portion 36 determines that the measurement data has not deviated from a control value (step S205: No), data collection continues.

Then, the control portion 36 periodically generates a report based on the collected data (step S206). The generated report is transmitted from the transmission portion 38 of the diagnostic device 32 (step S207). The reception portion 39 of the diagnosis result reception device 33 receives the report (step S208) and the report is displayed on the display portion 42 of the diagnosis result reception device 33, which can be checked by an operator.

On the other hand, if the control portion 36 determines that the measurement data has deviated from the control value (step S205: Yes), the control portion 36 generates diagnosis result data and transmits the diagnosis result data from the transmission portion 38 (step S209). For example, in the measurement data collected from the molding machine 3, if the pressure in aeration value has deviated from the lower limit of the control value, diagnosis result data indicating this is transmitted.

When the reception portion 39 of the diagnosis result reception device 33 receives the diagnosis result data (step S210), the display portion 42 of the diagnosis result reception device 33 displays a diagnosis result (warning) indicating that there is a risk that a fault will occur (step S211). For example, a diagnosis result (warning) is displayed indicating that the pressure in aeration value of the molding machine 3 has deviated from the lower limit of the control value and there is a risk that a fault will occur in the molding machine 3.

Furthermore, if the control portion 41 of the diagnosis result reception device 33 knows a specific method for dealing with the fault (step S212: Yes), the control portion 41 transmits, from the transmission portion 43 of the diagnosis result reception device 33 to the diagnostic device 32, instruction data for the equipment (any of the mixer 2, the molding machine 3, the core making machine 4, the pouring machine 5, the cooling machine 6, and the shake-out machine 7) within the casting equipment in which the measurement data has deviated from the control value, the instruction data instructing the equipment to change a setting condition so that the control value is not exceeded (step S213). For example, in the measurement data collected from the molding machine 3, if the pressure in aeration value has deviated from the lower limit of the control value, instruction data instructing the supply of air to increase by a predetermined value is transmitted to the diagnostic device 32 such that the pressure in aeration increases and returns to the range of the control values. Note that depending on the type of control value, instruction data that stops the equipment is transmitted in some cases.

When the reception portion 34 of the diagnostic device 32 receives the instruction data from the diagnosis result reception device 33 (step S214), the control portion 36 of the diagnostic device 32 transfers the instruction data from the diagnosis result reception device 33 to the equipment within the casting equipment in which the measurement data has deviated from the control value (step S215). For example, instruction data is transferred to the control portion 13 of the molding machine 3.

One of the control portions 12, 13, 14, 15, 16, 17 of the equipment that has received the instruction data from the diagnostic device 32 changes a setting condition in the equipment on the basis of the instruction data content (step S216). For example, the control portion 13 of the molding machine 3 increases the supply of air by a predetermined value on the basis of the instruction data. As a result, the pressure in aeration value again comes within range of the control values, and it is possible to obviate the occurrence of a fault due to a decrease in pressure in aeration.

If the control portion 41 of the diagnosis result reception device 33 does not know a specific method for dealing with the fault (step S212: No), the fault is dealt with by an operator who has checked the diagnosis result (warning) displayed on the display portion 42, and even after a setting condition has been changed, data collection continues (step S203), and the monitoring of the casting equipment by the diagnostic device 32 continues.

As mentioned previously, this series of operations is performed until the casting equipment monitoring system 31 (equipment of the casting equipment) stops (step S202: Yes). Once the casting equipment monitoring system 31 (devices of the casting equipment) stops, the monitoring of the casting equipment ends.

Note that in the present embodiment, a diagnosis result (warning) is displayed on the display portion 42 of the diagnosis result reception device 33 when there is a risk that a fault will occur, but a diagnosis result (warning) may also be displayed on the display portion 37 of the diagnostic device 32. Also, the diagnostic device 32 and/or the diagnosis result reception device 33 may be configured so as to have a speaker and issue a warning as audio. Furthermore, a configuration is also possible in which a diagnosis result (warning) is issued using both screen display and audio.

In this manner, according to the casting equipment monitoring system according to the second embodiment: the information collecting device collects, in real time, data measured by the devices of the casting equipment; the diagnostic device compares, in real time, the collected measurement data with a control value, and transmits a diagnosis result to the diagnosis result reception device if the diagnostic device determines that the collected data has deviated from the control value; and the diagnosis result reception device displays a diagnosis result (warning) indicating that there is a risk that a fault will occur. Consequently, even when distant from the casting equipment, it is possible to detect that the condition of the casting equipment is deteriorating before the casting equipment fails, or to detect that the quality of castings produced by the casting equipment is deteriorating before it becomes clear that the castings are defective products.

In addition, according to the casting equipment monitoring system according to the second embodiment, the diagnosis result reception device transmits instruction data for changing a setting condition in equipment to the diagnostic device, and the diagnostic device transfers the instruction data to the equipment that has deviated from a control value. This makes it possible to automatically stabilize the condition of casting equipment and the quality of castings even when distant from the casting equipment.

### Third Embodiment

Next, a third embodiment of the casting equipment monitoring system according to the present invention will be explained. Note that in the third embodiment explained below, the same reference numerals are used in the drawings to designate features common to those in the second embodiment, and descriptions thereof will be omitted. In the third embodiment, location information data is added to the diagnosis results and the reports generated by the diagnostic device in the second embodiment and transmitted to a diagnosis result reception device at a position remote from the casting equipment monitoring system.

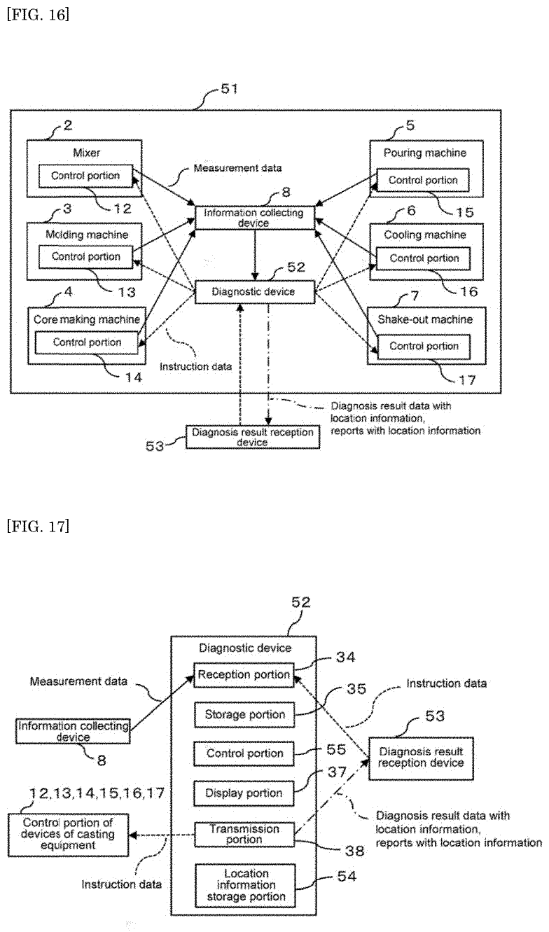

The third embodiment will be explained with reference to the attached drawings. FIG. 16 is a block diagram representing a functional configuration of the casting equipment monitoring system according to the third embodiment. The casting equipment monitoring system 51 comprises: casting equipment comprising a mixer 2, a molding machine 3, a core making machine 4, a pouring machine 5, a cooling machine 6, and a shake-out machine 7; an information collecting device 8; a diagnostic device 52; and a diagnosis result reception device 53.

The mixer 2 adds a binding agent and water to green sand and kneads them to produce kneaded sand. The mixer 2 comprises a control portion 12. The control portion 12 controls the operation of the mixer 2. All measurement data pertaining to a kneading step in the mixer 2 is aggregated into the control portion 12. The control portion 12 is a computer or a PLC.

The molding machine 3 molds master molds (cope and drag). The molding machine 3 comprises a control portion 13. The control portion 13 controls the operation of the molding machine 3. All measurement data pertaining to a master mold molding step in the molding machine 3 is aggregated into the control portion 13. The control portion 13 is a computer or a PLC.

The core making machine 4 molds cores. The core making machine 4 comprises a control portion 14. The control portion 14 controls the operation of the core making machine 4. All measurement data pertaining to a core molding step in the core making machine 4 is aggregated into the control portion 14. The control portion 14 is a computer or a PLC.

The pouring machine 5 pours molten metal into molds in which master molds and cores were subjected to mold assembly. The pouring machine 5 comprises a control portion 15. The control portion 15 controls the operation of the pouring machine 5. All measurement data pertaining to a pouring step in the pouring machine 5 is aggregated into the control portion 15. The control portion 15 is a computer or a PLC.

The cooling machine 6 cools molds into which molten metal was poured. The cooling machine 6 comprises a control portion 16. The control portion 16 controls the operation of the cooling machine 6. All measurement data pertaining to a cooling step in the cooling machine 6 is aggregated into the control portion 16. The control portion 16 is a computer or a PLC.

The shake-out machine 7 separates molds into foundry sand and castings that were cast. The shake-out machine 7 comprises a control portion 17. The control portion 17 controls the operation of the shake-out machine 7. All measurement data pertaining to a shake-out step in the shake-out machine 7 is aggregated into the control portion 17. The control portion 17 is a computer or a PLC.

The information collecting device 8 collects, in real time, data measured by the devices of the casting equipment (the mixer 2, the molding machine 3, the core making machine 4, the pouring machine 5, the cooling machine 6, and the shake-out machine 7). The information collecting device 8 is a data logger.

### (Diagnostic Device)

The diagnostic device 52 uses the collected measurement data to diagnose the condition of the devices of the casting equipment and the quality of castings produced by the casting equipment. FIG. 17 is a block diagram representing a functional configuration of the diagnostic device. The diagnostic device 52 comprises a reception portion 34, a location information storage portion 54, a storage portion 35, a control portion 55, a display portion 37, and a transmission portion 38.

The reception portion 34 receives, in real time, measurement data collected by the information collecting device 8, or receives instruction data from the diagnosis result reception device 53.

Location information data of the casting equipment being monitored by the casting equipment monitoring system 51 is stored in the location information storage portion 54. Note that the location information data may be not only location information of the casting equipment as a whole, but also location information regarding each of the devices of the casting equipment. As the format of the location information data, in some cases, information regarding the latitude and longitude where the devices are located is pre-stored, and in some cases, GPS (Global Positioning System) is integrated into the devices and GPS location information of the devices is stored.

In addition, if GPS has been integrated, the information collecting device 8 may periodically collect GPS location information of the devices. This makes continued monitoring possible even if a device of the casting equipment has moved for some reason.

Furthermore, GPS may also be integrated into the diagnostic device 52. Even if the diagnostic device 52 is stolen, the data collected until then can be prevented from being stolen by others by setting the data within the diagnostic device 52 to be automatically erased if the diagnostic device 52 moves by at least a predetermined distance (such as 1 km).

The storage portion 35 stores the received measurement data. Control values corresponding to the measurement data in the devices of the casting equipment are also pre-stored in the storage portion 35. Furthermore, the storage portion 35 stores reports generated by the control portion 55.

The control portion 55 compares, in real time, collected measurement data with the control values, and causes the display portion 37 to display a diagnosis result if the control portion 55 determines that collected data has deviated from a control value. Then, the control portion 55 adds location information data of the casting equipment to the generated diagnosis result data, and causes the transmission portion 38 to transmit this data as diagnosis result data with location information. When the control portion 55 receives instruction data from the diagnosis result reception device 53, the control portion 55 causes the transmission portion 38 to transmit the instruction data to the device of the casting equipment that has deviated from the control value. Furthermore, the control portion 55 periodically generates a report based on the collected data, adds location information data to the generated report, and causes the transmission portion 38 to transmit the report.

The display portion 37 displays the measurement data received by the reception portion 34, a report generated by the control portion 55, and a diagnosis result (warning) indicating that there is a risk that a fault will occur. Note that in the present embodiment, the display portion 37 may be omitted in the diagnostic device 52. The transmission portion 38 transmits diagnosis result data or reports to the diagnosis result reception device 53, and transmits instruction data to the device of the casting equipment that has deviated from the control value. The diagnostic device 52 is a computer.

Note that in the present embodiment, emails are used when the diagnostic device 52 transmits diagnosis result data or reports with location information to the diagnosis result reception device 53 and when the diagnostic device 52 receives instruction data from the diagnosis result reception device 53, but other methods may be used.

### (Diagnosis Result Reception Device)

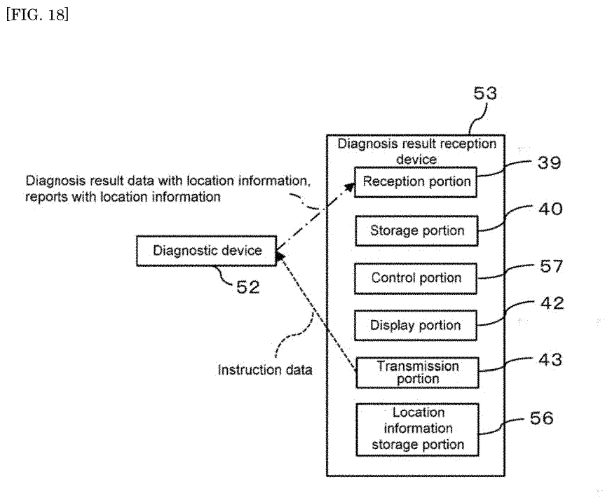

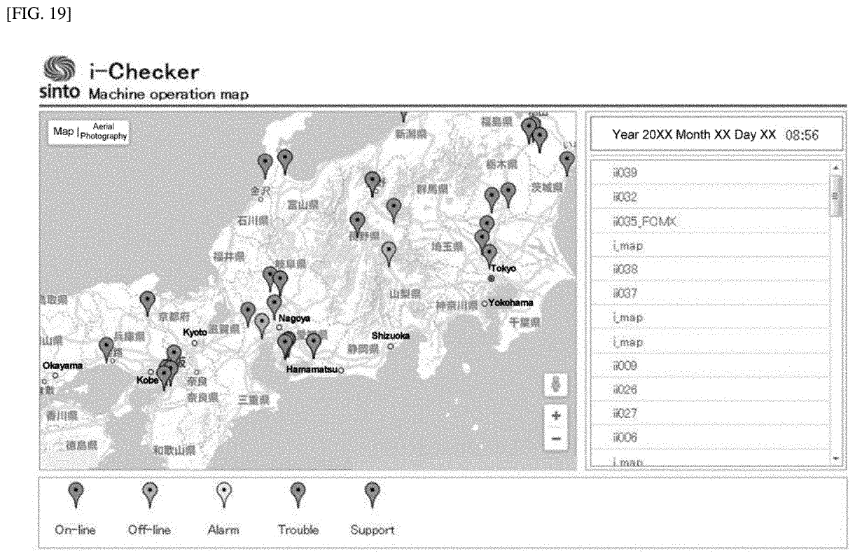

The diagnosis result reception device 53 receives diagnosis result data with location information data or reports with location information data from the diagnostic device 52. In addition, the diagnosis result reception device 53 gives change instructions to the diagnostic device 52 based on the diagnosis result data. The diagnosis result reception device 53 is at a position remote from the casting equipment, the information collecting device 8, and the diagnostic device 52. FIG. 18 is a block diagram representing a functional configuration of the diagnosis result reception device. The diagnosis result reception device 53 comprises a reception portion 39, a location information storage portion 56, a storage portion 40, a control portion 57, a display portion 42, and a transmission portion 43.

The reception portion 39 receives diagnosis result data with location information data or reports with location information data from the diagnostic device 52.

Location information data of casting equipment being monitored by the casting equipment monitoring system 51 is stored in the location information storage portion 56.

The storage portion 40 stores received diagnosis result data with location information data or reports with location information data. Countermeasures for when measurement data from devices of the casting equipment has deviated from control values are also pre-stored in the storage portion 40.

The control portion 57 causes diagnosis results (warnings) indicating that there is a risk that a fault will occur, or reports with location information data, to be displayed on the display portion 42 based on diagnosis result data with location information data.

Furthermore, on the basis of diagnosis result data with location information data, the control portion 57 causes the transmission portion 43 to transmit, to the device of the casting equipment that has deviated from a control value, instruction data for changing a setting condition in the device so that the control value is not exceeded.

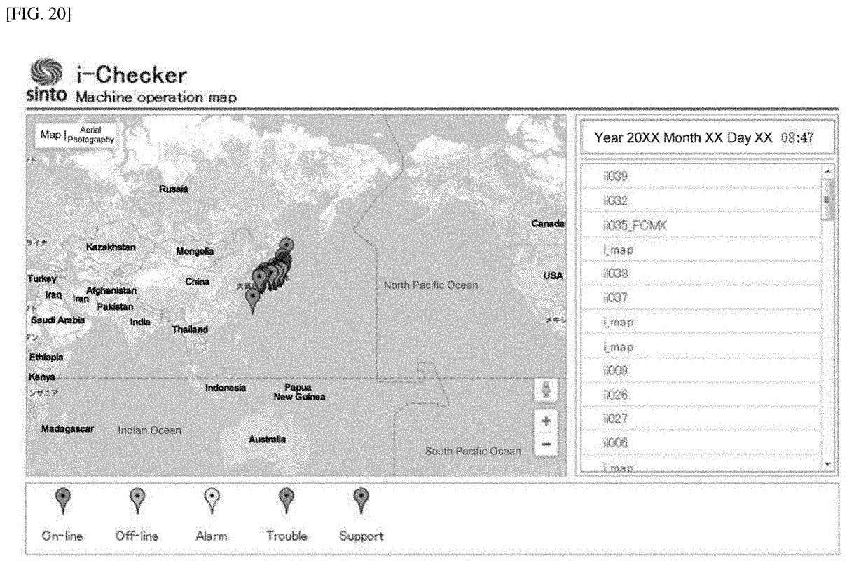

The display portion 42 displays diagnosis results (warnings) or reports. In addition, when displaying a diagnosis result (warning) or a report, the location information data included in diagnosis result data with location information data or in a report with location information data is collated with the location information data stored in the location information storage portion 56, which is displayed together therewith as map information. FIG. 19 illustrates an example of map information displayed on the display portion 42. In addition, FIG. 20 illustrates another example of map information displayed on the display portion 42. Here, FIG. 19 shows a casting equipment monitoring system 51 built in Japan, while FIG. 20 shows a casting equipment monitoring system 51 built across the globe.

The transmission portion 43 transmits instruction data to the diagnostic device 52. The diagnosis result reception device 53 is a computer.

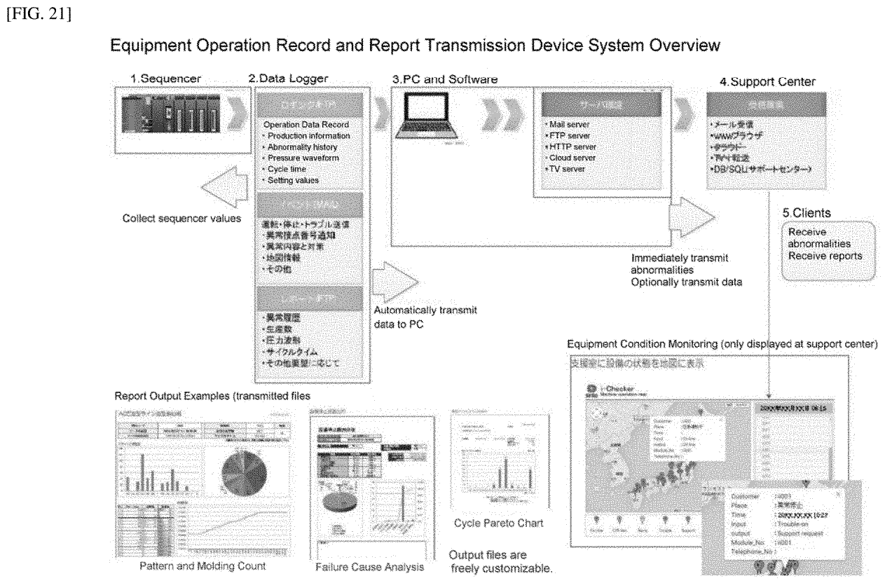

Note that in the present embodiment, emails are used when the diagnosis result reception device 53 receives diagnosis result data or reports with location information from the diagnostic device 52 and when the diagnosis result reception device 53 transmits instruction data to the diagnostic device 52, but other methods may be used. FIG. 21 illustrates an overview of the casting equipment monitoring system 51.

### (Method for Monitoring Casting Equipment)

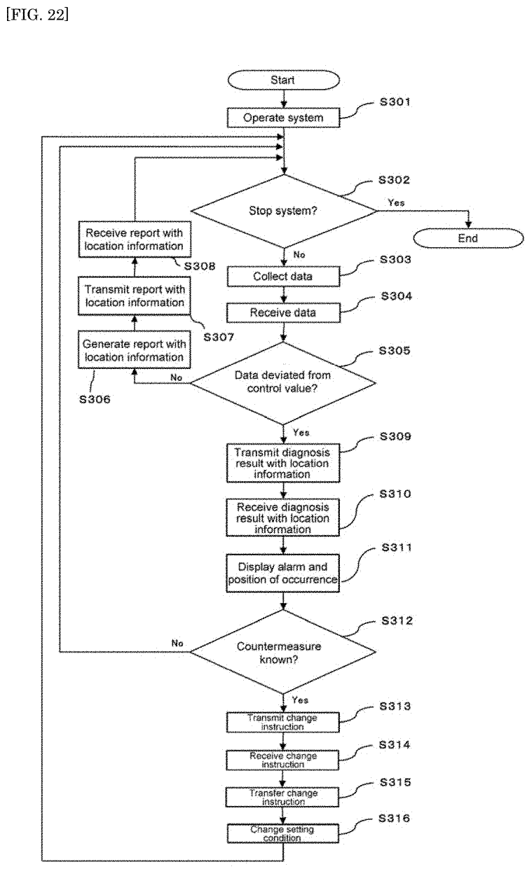

Next, the method for monitoring casting equipment using the casting equipment monitoring system 51 according to the third embodiment will be explained. FIG. 22 is a flow chart illustrating the method for monitoring casting equipment using the casting equipment monitoring system 51 according to the third embodiment.

First, the casting equipment monitoring system 51 (devices of the casting equipment) is operated (step S301). Then, the casting equipment is continuously monitored until the casting equipment monitoring system 51 (devices of the casting equipment) stops (step S302: Yes).

Simultaneously with the operation of the casting equipment monitoring system 51, the information collecting device 8 collects, in real time, data measured by the mixer 2, the molding machine 3, the core making machine 4, the pouring machine 5, the cooling machine 6, and the shake-out machine 7 (step S303).

Next, the reception portion 34 of the diagnostic device 52 receives, in real time, the measurement data collected by the information collecting device 8 (step S304).

Next, the control portion 55 of the diagnostic device 52 compares, in real time, the received measurement data with control values pre-stored in the storage portion 35 of the diagnostic device 52 (step S305). If the control portion 55 determines that the measurement data has not deviated from a control value (step S305: No), data collection continues.

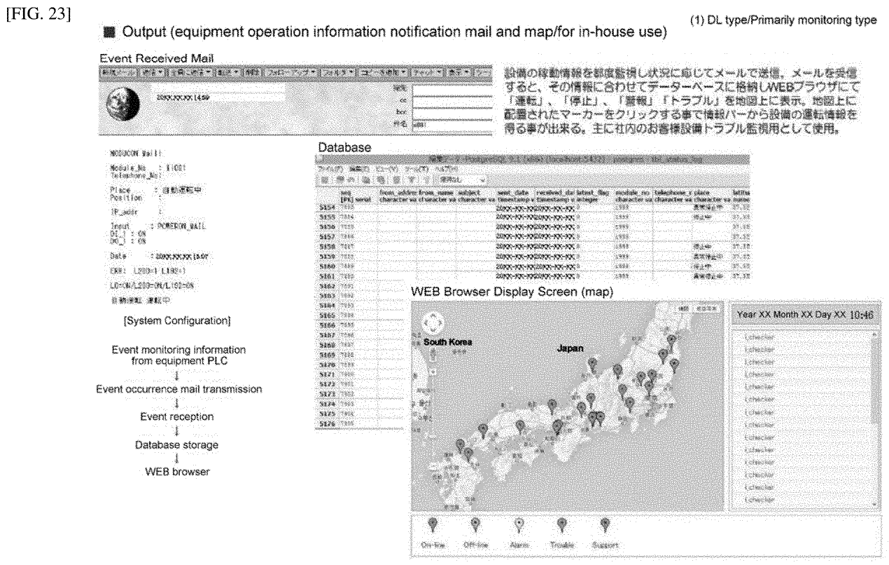

Then, the control portion 55 periodically generates a report with location information from the collected data (step S306). A generated report with location information is transmitted from the transmission portion 38 of the diagnostic device 52 (step S307). The reception portion 39 of the diagnosis result reception device 53 receives the report with location information (step S308), and both the report and a map showing the position of the casting equipment for which the report was generated are displayed on the display portion 42 of the diagnosis result reception device 53. This allows an operator to easily check the position of the casting equipment for which the report was generated. FIG. 23 illustrates an example of a report generated by the control portion 55 of the diagnostic device 52.

On the other hand, if the control portion 55 determines that the measurement data has deviated from the control value (step S305: Yes), the control portion 55 generates diagnosis result data with location information and transmits this data from the transmission portion 38 (step S309).

When the reception portion 39 of the diagnosis result reception device 53 receives the diagnosis result data with location information (step S310), the display portion 42 of the diagnosis result reception device 53 displays both a diagnosis result (warning) indicating that there is a risk that a fault will occur and a map showing the position of the casting equipment for which there is a risk that a fault will occur (step S311). This allows an operator to easily check the position of the casting equipment for which there is a risk that a fault will occur.

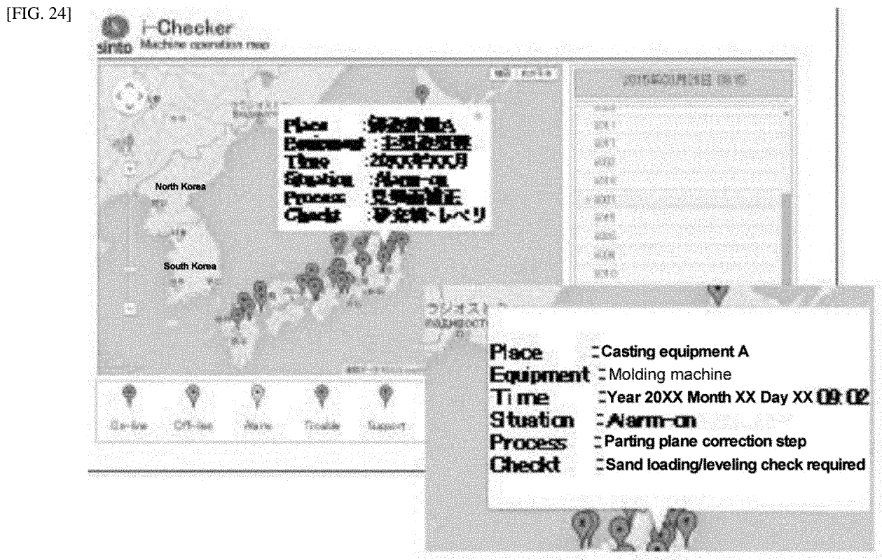

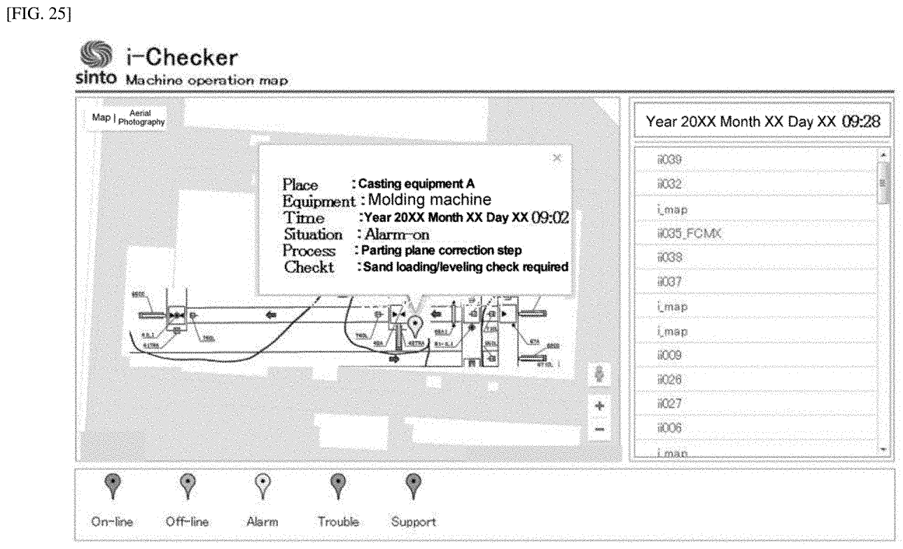

FIG. 24 illustrates an example of a screen displayed on the display portion 42. In the present drawing, it can be understood at a glance that an issue is occurring in the molding machine of casting equipment A. The present drawing displays the location of casting equipment A on a map of Japan, but it is also possible to specifically display the area in the casting equipment where there is an issue. FIG. 25 illustrates another example of a screen displayed on the display portion 42. In the present drawing, the area where an issue in the molding machine of casting equipment A is occurring can be understood at a glance.

Furthermore, in FIGS. 24 and 25, the status of casting equipment is displayed in different colors, so the condition of the casting equipment can be recognized at a glance. For example, in FIG. 24, if an issue occurs in casting equipment, a mark representing the location of the casting equipment changes from green to red, which allows an operator to quickly become aware that the issue has occurred. Furthermore, in FIG. 25, if an issue occurs in casting equipment, a mark representing the area in casting equipment where there is an issue changes from green to red, which allows an operator to quickly become aware of the occurrence of the issue as well as the position of occurrence thereof.

Furthermore, if the control portion 57 of the diagnosis result reception device 53 knows a specific method for dealing with the fault (step S312: Yes), the control portion 57 transmits, from the transmission portion 43 of the diagnosis result reception device 53 to the diagnostic device 52, instruction data for the equipment (any of the mixer 2, the molding machine 3, the core making machine 4, the pouring machine 5, the cooling machine 6, and the shake-out machine 7) within the casting equipment in which the measurement data has deviated from the control value, the instruction data instructing the equipment to change a setting condition so that the control value is not exceeded (step S313). Note that, depending on the type of control value, instruction data that stops the equipment is transmitted in some cases.

When the reception portion 34 of the diagnostic device 52 receives the instruction data from the diagnosis result reception device 53 (step S314), the control portion 55 of the diagnostic device 52 transfers the instruction data from the diagnosis result reception device 53 to the equipment within the casting equipment in which the measurement data has deviated from the control value (step S315).

One of the control portions 12, 13, 14, 15, 16, 17 of the equipment that has received the instruction data from the diagnostic device 52 changes a setting condition in the equipment on the basis of the instruction data content (step S316). If the control portion 57 of the diagnosis result reception device 53 does not know a specific method for dealing with the fault (step S312: No), the fault is dealt with by an operator who has checked the diagnosis result (warning) displayed on the display portion 42, and even after a setting condition has been changed, data collection continues (step S303), and the monitoring of the casting equipment by the diagnostic device 52 continues.

As mentioned previously, this series of operations is performed until the casting equipment monitoring system 51 (equipment of the casting equipment) stops (step S302: Yes). Once the casting equipment monitoring system 51 (devices of the casting equipment) stops, the monitoring of the casting equipment ends.

Note that in the present embodiment, both a diagnosis result (warning) and a map showing the position of the casting equipment are displayed on the display portion 42 of the diagnosis result reception device 53 when there is a risk that a fault will occur, but a diagnosis result (warning) may also be displayed on the display portion 37 of the diagnostic device 52. Also, the diagnostic device 52 and/or the diagnosis result reception device 53 may be configured so as to have a speaker and issue a diagnosis result (warning) as audio. Furthermore, a configuration is also possible in which a diagnosis result (warning) is issued using both screen display and audio.

In this manner, according to the casting equipment monitoring system according to the third embodiment, the diagnosis result reception device displays both a diagnosis result (warning) indicating that there is a risk that a fault will occur and a map showing the position of casting equipment for which there is a risk that a fault will occur. This allows an operator to easily check the position of the casting equipment for which there is a risk that a fault will occur.

Note that in the first to third embodiments, the casting equipment comprises, but is not limited to, a mixer, a molding machine, a core making machine, a pouring machine, a cooling machine, and a shake-out machine. For example, the casting equipment may comprise conveyance devices such as a conveyor that conveys molds, and measurement data pertaining to the conveying step can be collected in real time by the information collecting device and diagnosed by the diagnostic device.

In addition, in the first to third embodiments, the information collecting device collects, in real time, the data measured by the casting equipment, but for example, if an event occurs, such as equipment failure or the occurrence of trouble in equipment, then data is additionally collected from that equipment. This is the same whether, for example, there is a failure due to human error or the occurrence of trouble due to human error.

In addition, in the second and third embodiments, the diagnostic device generates a diagnosis result and a report based on measurement data collected by an information collecting device, and the diagnosis result reception device receives the diagnosis result and the report. However, a configuration is also possible in which the diagnostic device transmits measurement data collected by the information collecting device directly to the diagnosis result reception device and the diagnosis result reception device generates a diagnosis result and a report based on the measurement data.

In addition, in the third embodiment, it is envisaged that GPS is integrated into the diagnostic device, but GPS may also be integrated into the diagnostic device in the first and second embodiments. In this case as well, even if the diagnostic device is stolen, the data collected until then can be prevented from being stolen by others by setting the data within the diagnostic device to be automatically erased if the diagnostic device moves by at least a predetermined distance (such as 1 km).

Various embodiments of the present invention were explained above, but the explanations above are not restrictive of the present invention, and various modifications including the deletion, addition, and substitution of structural components may be contemplated within the technical scope of the present invention.

### REFERENCE SIGNS LIST

1, 31, 51 Casting equipment monitoring system
2 Mixer
3 Molding machine
4 Core making machine
5 Pouring machine
6 Cooling machine
7 Shake-out machine
8 Information collecting device
9, 32, 52 Diagnostic device
12, 13, 14, 15, 16, 17, 23, 36, 41, 55, 57 Control portion
21, 34, 39 Reception portion
22, 35, 40 Storage portion
24, 37, 42 Display portion
25, 38, 43 Transmission portion
33, 53 Diagnosis result reception device
54, 56 Location information storage portion

1. A casting equipment monitoring system, comprising:
an information collecting device that collects, in real time, data measured by equipment within casting equipment; and
a diagnostic device that compares, in real time, the collected data with a control value, and displays a diagnosis result if the diagnostic device determines that the collected data has deviated from the control value.

2. The casting equipment monitoring system according to claim 1, wherein the diagnostic device, if the collected data has deviated from the control value, further transmits an instruction to the equipment that has deviated from the control value.

3. The casting equipment monitoring system according to claim 2, wherein the instruction includes content for changing a setting condition in the equipment that has deviated from the control value.

4. The casting equipment monitoring system according to claim 2, wherein the instruction includes content for stopping the equipment that has deviated from the control value.

5. The casting equipment monitoring system according to claim 1, wherein the diagnostic device further periodically generates a report based on the collected data.

6. The casting equipment monitoring system according to claim 1, wherein the diagnostic device, when displaying the diagnosis result, provides location information of the equipment that has deviated from the control value.

7. The casting equipment monitoring system according to claim 6, wherein the location information further includes location information of the casting equipment.

8. The casting equipment monitoring system according to claim 1, wherein the equipment is at least one selected from among a mixer, a molding machine, a core making machine, a pouring machine, a cooling machine, and a shake-out machine.

9. A casting equipment monitoring system, comprising:
an information collecting device that collects, in real time, data measured by equipment within casting equipment;
a diagnostic device that compares, in real time, the collected data with a control value, and transmits a diagnosis result if the diagnostic device determines that the collected data has deviated from the control value; and
a diagnosis result reception device that receives and displays the diagnosis result.

10. The casting equipment monitoring system according to claim 9, wherein the diagnosis result reception device transmits an instruction to the diagnostic device, and the diagnostic device transmits the instruction to the equipment that has deviated from the control value.

11. The casting equipment monitoring system according to claim 10, wherein the instruction includes content for changing a setting condition in the equipment that has deviated from the control value.

12. The casting equipment monitoring system according to claim 10, wherein the instruction includes content for stopping the equipment that has deviated from the control value.

13. The casting equipment monitoring system according to claim 9, wherein transmission and reception between the diagnostic device and the diagnosis result reception device is performed by email.

14. The casting equipment monitoring system according to claim 9, wherein the diagnosis result reception device changes a color of the diagnosis result with respect to other display content and displays the diagnosis result.

15. The casting equipment monitoring system according to claim 9, wherein the diagnostic device further periodically generates a report based on the collected data and transmits the report to the diagnosis result reception device.

16. The casting equipment monitoring system according to claim 9, wherein the diagnosis result reception device, when displaying the diagnosis result, provides location information of the equipment that has deviated from the control value.

17. The casting equipment monitoring system according to claim 9, wherein the equipment is at least one selected from among a mixer, a molding machine, a core making machine, a pouring machine, a cooling machine, and a shake-out machine.

18. A casting equipment monitoring method, comprising:
collecting, in real time, data measured by equipment within casting equipment; and
comparing, in real time, the collected data with a control value, and displaying a diagnosis result upon determining that the collected data has deviated from the control value.

19. The casting equipment monitoring method according to claim 18, wherein an instruction is transmitted to the equipment that has deviated from the control value.

20. The casting equipment monitoring method according to claim 18, wherein when displaying the diagnosis result, location information of the equipment that has deviated from the control value is provided.

21. A casting equipment monitoring method, comprising:
collecting, in real time, data measured by equipment within casting equipment;
a diagnostic device comparing, in real time, the collected data with a control value, and transmitting a diagnosis result to a diagnosis result reception device if the diagnostic device determines that the collected data has deviated from the control value; and
the diagnosis result reception device receiving and displaying the diagnosis result.

22. The casting equipment monitoring method according to claim 21, wherein the diagnosis result reception device transmits an instruction to the diagnostic device, and the diagnostic device transmits the instruction to the equipment that has deviated from the control value.

23. The casting equipment monitoring method according to claim 18, wherein the data is also collected if the equipment has failed, or if trouble has occurred in the equipment.

24. The casting equipment monitoring method according to claim 23, wherein the data is also collected if the equipment has failed due to human error, or if trouble has occurred in the equipment due to human error.

25. The casting equipment monitoring method according to claim 21, wherein the diagnosis result reception device, when displaying the diagnosis result, provides location information of the equipment that has deviated from the control value.
